(19) United States
(12) Patent Application Publication
(10) Pub. No.: US 2008/0102866 A1
(43) Pub. Date: May 1, 2008

(54) Advanced Lawful Interception of Sms

(76) Inventors: Lorenzo Fiorillo, San Nicola la Strada (CE) (IT); Enrico De Luca, Caserta (IT); Pompeo Santoro, Baronissi (IT)

Correspondence Address: ERICSSON INC., 6300 LEGACY DRIVE, M/S EVR 1-C-11, PLANO, TX, 75024, US

(21) Appl. No.: 11/721,491

(22) PCT Filed: Oct. 28, 2005
(86) PCT No.: PCT/SE05/01623

§ 371 Date: Jun. 12, 2007

(30) Foreign Application Priority Data
Dec. 16, 2004 (EP) 04445129.2

(51) Int. Cl. H04Q 7/20

(52) U.S. Cl. 455/466

(57) ABSTRACT

The present invention relates to methods and arrangements to intercept Short Message Services (SMS) in a telecommunication system (TS). The telecommunication system comprises a telecommunication Network (PLMN-A) that comprises a Short Message Service Centre (SMSC; ICE, IAP) responsible for relaying Short Messages (SMs) to/from all subscribers belonging to the telecommunication network. The method comprises the following steps: Receiving in the Short Message Service Centre (SMSC), a request to monitor Short Messages (SMs) related to a subscriber (A, Al, B, C, D, E, F) in the telecommunication system (TS). Registering in the Short Message Service Centre (SMSC) a Short Message (SM) related to the monitored subscriber (A, Al, B, C, D, E, F). Delivering from the Short Message Service Centre (SMSC), information related to the registered Short Message.

### TECHNICAL FIELD OF THE INVENTION

The present invention relates to methods and arrangements to intercept Short Message Services in a telecommunication system.

### DESCRIPTION OF RELATED ART

Short Message Services SMS provides a means of sending messages of limited size to and from mobiles. The provision of SMS makes use of a Short Message Service Centre SMSC, which is responsible for the relaying, store and forwarding of a short message. In the technical specification 3GPP TS 23.040 “Short Message Services for GSM/UMTS networks” is described.

At the reception of a Short Message from a mobile handset, i.e. a mobile originating short message, a Mobile Services Switching Centre MSC or a Serving GPRS support Node SGSN forwards the Short Message SM to an SMS inter-working MSC (SMS-IWMSC). The SMS-IWMSC submits it to the SMSC. The SM can be destined to other mobile subscribers or to subscribers on fixed networks such as paging networks or electronic mail networks.

Upon reception of a Short Message from a Short Message Entity the SMSC relays the SM to the SMS gateway MSC (SMS-GMSC). The SMS-GMSC interrogates a home location register HLR for routing information in order to deliver the short message to a “visited” MSC (or SGSN) in which a recipient mobile station temporarily is located.

Since SMS has reached a high market penetration there is a demand for monitoring of Short Messages. One kind of monitoring is lawful interception. Lawful interception architecture and functions is described in 3GPP TS 33.107 (release 5) and handover interface for lawful interception is described in 3GPP TS 33.108. An Administration Function (ADMF) has the task to start, stop or modify interception of a specific target. A delivery function DF2 distributes to the Law Enforcement Agencies equipment, over a related Handover Interface HI2 the Intercept Related Information, while the Delivery Function DF3 is responsible of distribution Content of Communication i.e. speech and data over the Handover Interface HI3. Exceptionally, in case of SMS interception, either the Handover Interface HI2 or HI3 can be alternatively used to distribute both the SM interception related data and SM content. In practice, HI2 is mostly used.

According to current ETSI/3GPP Lawful Interception standards, SMS can only be intercepted in 2 G/3 G MSC Server or in 2 G/3 G Gateway MSC and SGSN. Furthermore, the possible target identifiers for the interception are: MSISDN, IMSI and IMEI.

Due to the above limitations, there are a number of cases where interception of SMS according to known technique is not possible:
Short Messages Does Not Reach the MSC or SGSN.
   Interception of Mobile Terminating Short Message is not possible in case the relay of the SM to the Mobile Service Switching Centre MSC or Serving GPRS Support Node SGSN currently serving the monitored subscriber, is not possible within a period of time greater than the validity period indicator associated with the SM for reason like:
      Congestion of the MSC or SGSN
      HLR knows that the monitored user is not reachable
      HLR knows that the recipient MS has no memory available for SM
   Short Messages not delivered to a monitored subscriber have to be considered at least as important as unsuccessful call attempts to a monitored subscriber. While call attempts to a not reachable monitored subscriber can reveal to a monitoring agency only intercept related data such as the identity of calling user, interception of SMS provides, in addition to that, the Short Message Content also, in other words the “LI Call Content”.
Short Message from/to a Monitored Subscriber Roaming Abroad
   In case the monitored subscriber roaming abroad is the recipient of the Short Message, the SMS is delivered via a MSC or SGSN not under the jurisdiction of the national Law Enforcement Agency LEA. According to prior art, these communications cannot be intercepted, at least not in the path between SMSC—MSC (or SGSN)—recipient MS. In the originating path there are also many cases where this SM could be also invisible to the LEA:
      Originating SME is a 2 G/3 G mobile phone also roaming abroad
      Originating SME is an e-mail subscription with e-mail server also abroad
      Originating SME is an application directly connected to the SMSC
   In case the monitored subscriber roaming abroad is the originator of the Short Message, the SMS is submitted to an MSC or SGSN currently serving the subscriber. As above LEA has no jurisdiction on these nodes. In the terminating path: SMSC—MSC (or SGSN)—terminating MS, there are also many cases where the SM cannot be intercepted:
      Recipient SME is a 2 G/3 G mobile subscriber also abroad
      Recipient SME is an e-mail subscription and the e-mail server is abroad
      Recipient SME is an application directly connected to the SMSC
SMS Inter-Working with E-mail Service and Wireline Networks
   Currently the possible target identifiers for the interception of SMS are MSISDN, IMSI and IMEI. In case of SMS inter-working with e-mail service, the target identifier could be an e-mail address. ETSI/3GPP standards do not provide any means to intercept SMS to/from e-mail address or users on wireline networks. Although it is possible to intercept in the e-mail server these communications, when the e-mail servers are abroad it is not possible for national LEAs to intercept in these nodes. On the other hand, in case of wireline subscribers it is not possible to define them as targets in the MSC, SGSN nodes.

In FIG. 1 interception of Short Messages according to prior art is shown. FIG. 1 discloses a communication system located in two countries. In “LEA Country”, a Law Enforcement Monitoring Facility LEMF is located. “Abroad” represents a country other than the LEA Country. A Public Land Mobile Network PLMN-A is located in the LEA Country. The LEMF is attached to a MSC and/or SGSN located in PLMN-A via HI2 and DF2. A mobile subscriber A is communicating via the PLMN-A. The PLMN-A is connected to a Public Land Mobile Network PLMN-B located abroad. A mobile subscriber B is communicating via the PLMN-B. The PLMN-A is also connected to a WIRELINE system located in LEA Country and to an INTERNET network covering both the LEA Country and abroad. A subscriber C using a computer terminal located abroad and a subscriber D using a computer terminal located in LEA Country are communicating via the INTERNET. Two stationary telephone sets E and F are communicating via the wireline system.

With current technology, using the MSC/SGSN as Intercepting Control Element as in FIG. 1, the SMS can be intercepted in the following cases:

A Target
All the SMs sent and received by A can be intercepted.

B Target
Only SMs sent from B and received by A can be intercepted.
Only SMs received by B when the sender is A can be intercepted.

With the current technology the SMS cannot be intercepted in the following cases:

C, D, E, F Target
It is not possible to define these target identities for SMS interception, so interception involving these subscribers is not possible.

A Target
Mobile Terminating Short Messages that due to timer expiration does not reach the serving MSC or the SGSN is not possible to intercept.
Mobile Terminating or Originating Short Messages when the target is roaming abroad is not possible to intercept.

### SUMMARY OF THE INVENTION

The present invention relates to a problem how to monitor Short Messages that normally never reach a monitoring facility due to e.g. lack of jurisdiction, loss of message before the final destination is reached, or target user not being a mobile subscriber.

A purpose with the invention is to intercept Short Messages that are not possible to intercept when current monitoring techniques are used.

The problem is solved by the invention by introducing in a telecommunication network, a new node as Intercepting Control Element which node relays Short Messages related to all subscribers belonging to the telecommunication network.

More in detail, the problem is solved by a method and an arrangement to intercept Short Message Service in a telecommunication system comprising a telecommunication network that comprises an Access Point responsible for relaying Short Messages to/from all subscribers belonging to the telecommunication network. The method comprises the following method steps:
Receiving to the Access Point, a request to monitor Short Messages related to a subscriber in the telecommunication system.
Registering in the Short Message Service Centre a Short Message related to the monitored subscriber.
Delivering from the Short Message Service Centre to an Intercept Mediation and Delivery Unit, information related to the registered Short Message.

An advantage of the invention is the possibility to provide a Law Enforcement Agency with accurate interception of Short Message Service handled by a Short Message Service Centre under jurisdiction, regardless of the type of Short Message Entity sending or receiving the message.

Another advantage of the invention is the possibility of interception based on two new target identity types, i.e. e-mail address and subscriber numbers in wireline networks.

A further advantage of the invention is less administrative work and simpler network set-up since interception can be concentrated just in a single Intercepting Control Element.

The invention will now be described more in detail with the aid of preferred embodiments in connection with the enclosed drawings.

### BRIEF DESCRIPTION OF THE DRAWINGS

FIG. 1 shows a block schematic illustration of interception of short messages according to prior art.

FIG. 2 shows a block schematic illustration of interception of short messages according to the invention.

FIG. 3 shows a block schematic illustration of interception of short messages according to the invention at a traffic case when a Short Message do not reach its destination.

FIG. 4 shows a block schematic illustration of interception of short messages according to the invention at a traffic case when a monitored terminating subscriber is roaming abroad.

FIG. 5 shows a block schematic illustration of interception of short messages according to the invention at a traffic case when a monitored originating subscriber is roaming abroad.

FIG. 6 shows a block schematic illustration of interception of short messages according to the invention at a traffic case when a monitored terminating subscriber belongs to a wireline (or internet) network.

FIG. 7 shows a block schematic illustration of interception of short messages according to the invention at a traffic case when a monitored originating subscriber belongs to an internet (or wireline) network.

FIG. 8 shows a flow chart illustrating some essential method steps of the invention.

### DETAILED DESCRIPTION OF EMBODIMENTS

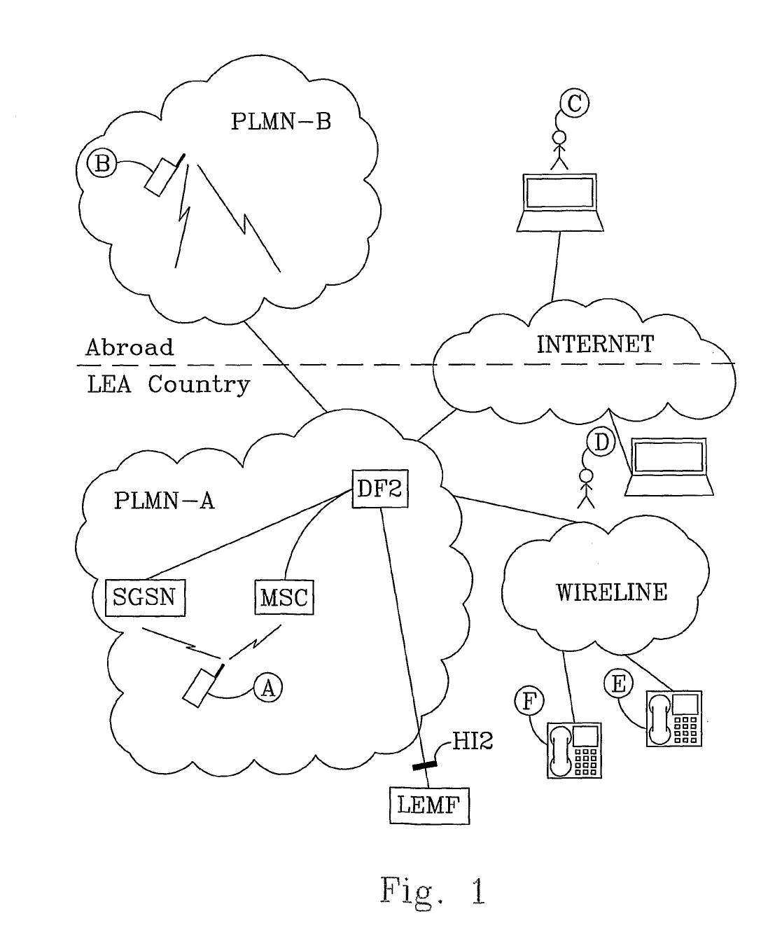

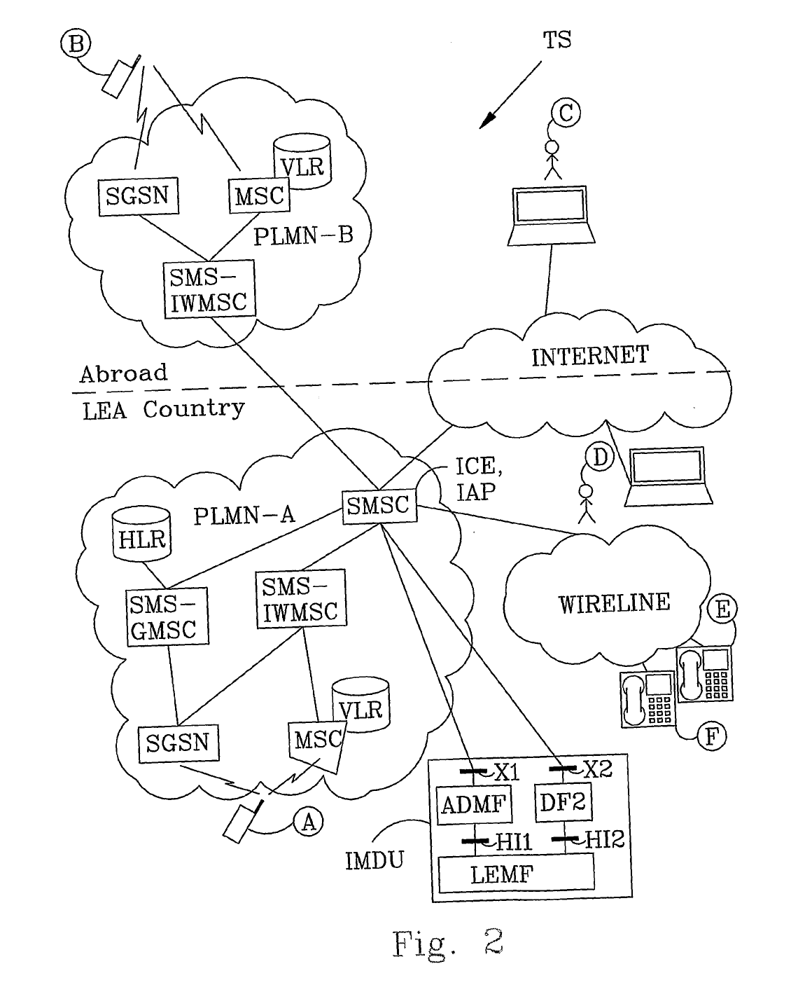

FIG. 2 discloses a telecommunication system TS configured according to the invention. In this example the telecommunication system TS comprises a Public Land Mobile Network PLMN-A, a Public Land Mobile Network PLMN-B, an Internet Network INTERNET and a wireline Network WIRELINE. Like in FIG. 1 the communication system TS is located in two countries. A Law Enforcement Monitoring Facility LEMF is located in “LEA Country” while “Abroad” represents a country other than the LEA Country. The PLMN-A comprises a Short Message Service Centre SMSC that is responsible for relaying, store and forwarding of Short Messages SMs to and from subscribers belonging to the network PLMN-A, i.e. subscribers that have their home location in PLMN-A. Subscribers having their home location in PLMN-A are registered in a Home Location Register HLR in PLMN-A. Upon reception of a Short Message to a subscriber A belonging to PLMN-A, the SMSC relays the SM to a SMS Gateway Mobile Switching Centre SMS-GMSC. The SMS-GMSC interrogates the Home Location Register HLR for routing information in order to deliver the Short Message to a visited MSC or SGSN. If communication takes place in circuit domain, delivery is to MSC and if communication takes place in packet domain delivery is to SGSN. The Short Message is then forwarded to subscriber A. The Short Message can be sent from other mobile subscribers or from subscribers on fixed networks such as paging networks or electronic mail networks. The SMS-GMSC is typically integrated with the SMSC. Upon reception of a Short Message from the subscriber A, the MSC (or SGSN) forwards the SM to the SMS Inter-Working MSC (SMS-IWMSC). The SMS-IWMSC submits it to the SMSC. The Short Message can be destined to other mobile subscribers or to subscribers on fixed networks such as paging networks or electronic mail networks. An Intercept Mediation and Delivery Unit IMDU is disclosed in FIG. 2. The different parts of the IMDU belong to prior art and are disclosed in current Lawful Interception standards (see 3GPP TS 33.108 and 3GPP TS 33.107—Release 6). The IMDU comprises the Law Enforcement Monitoring Function LEMF. The LEMF is connected to three Mediation Functions respectively for ADMF, DF2, DF3 (DF3 is not shown in the figure) i.e. an Administration Function ADMF and two Delivery Functions DF2 and DF3. The Administration Function and the Delivery Function DF2 in FIG. 2 are each one connected to the LEMF via standardized interfaces H1 and H2, and connected to the SMSC i.e. to the so called Intercept Access Point IAP (or Intercepting Control Element ICE when 3GPP terminology is used) via the interfaces X1 and X2. The ADMF is connected via the interfaces HI1/X1 while DF2 is connected via HI2/X2. The messages sent from LEMF to ADMF via HI1 and from the ADMF to the network via the X1 interface comprise identities of a target that is to be monitored. The Delivery Function DF2 receives Intercept Related Information IRI from the network via the X2 interface, and DF2 is used to distribute the IRI to relevant Law Enforcement Agencies via the HI2 interface. Intercept Related Information IRI, received by DF2 is triggered by Events that in Circuit Switching domain are either call related or non-call related. In Packet Switching domain the events are session related or session unrelated. Commonly the ADMF and DF2 are parts of the service provider domain, i.e. the PLMN-A and located distinctly from the LEMF.

A mobile subscriber B belongs to PLMN-B and SMS communications take place in the same way as in PLMN-A. PLMN-B can communicate with SMSC in PLMN-A. The PLMN-A is also connected to a WIRELINE system located in LEA Country and to an INTERNET network covering both the LEA Country and abroad. A subscriber C using a computer terminal located abroad and a subscriber D using a computer terminal located in LEA Country are communicating via the INTERNET. Two stationary telephone sets E and F are communicating via the wireline system. The different telecommunication systems will be further discussed later in the description when different traffic cases will be explained.

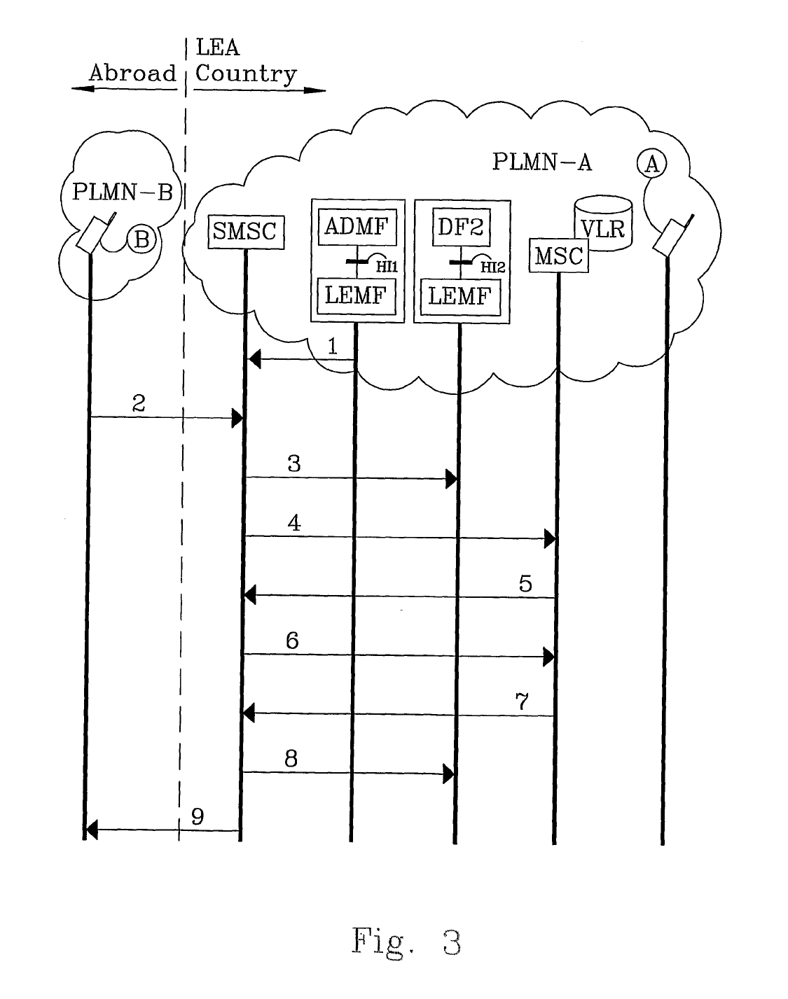

FIG. 3 discloses a method according to a first embodiment of the invention. Some of the entities from FIG. 2 can also be seen in FIG. 3. The first embodiment discloses a method for SMS interception when the Short Message does not reach the MSC or the SGSN within a period of time greater than a validity periodic indicator associated with the Short Message due to for example:
a Congestion of the MSC or SGSN
HLR knows that the monitored user is not reachable
HLR knows that the recipient MS has no memory available for SM

In this example the mobile subscriber A is the target for interception and the mobile subscriber B sends a Short Message to subscriber A. The method according to the first embodiment comprises the following method steps:
The Law Enforcement Monitoring Function LEMF sends via the HI1 interface, a request 1 to the Administration Function ADMF to activate interception of Short Messages related to the mobile subscriber A. The subscriber identity (MSISDN) is sent in the request 1 and defines subscriber A. The ADMF forwards the requests 1 via the interface X1 to the Short Message Service Centre SMSC. The received subscriber identity is stored in the SMSC. In general, the request originating from a search warrant is communicated from the authorization institution. The request may also be communicated by an intermediary, such as a human operator who receives the command from the authorized source.
A Short Message is sent 2 from the mobile subscriber B to the SMSC. The Short Message comprises an identity that identifies subscriber A as called party.
The called party number, which identifies subscriber A is received in the SMSC. The called party number is stored in the SMSC.
The SMSC verifies that the received subscriber number identifies subscriber A as a target for monitoring.
The SMSC forwards 3 Intercept Related Information IRI related to the monitored subscriber A via the X2 interface to the delivery function DF2 and from DF2 to the Law Enforcement Monitoring Function LEMF via the HI2 interface. The IRI comprises an SMS-report.
The SMSC relays the Short Message to the SMS-GMSC (see FIG. 2). The SMS-GMSC interrogates the Home Location Register HLR for routing information and receives information about the MSC where A at the moment is located.
The SMSC relays 4 the Short Message to the MSC where subscriber A is located.
The MSC is found to be in congestion state and a report 5 of unsuccessful delivery is sent from the MSC to the SMSC. The method steps 4 and 5 will be repeated 6 and 7 until successful delivery or lapse of a Short Message validity period in the SMSC.
The Short Message validity period expires in the SMSC.
The Short Message is deleted from the Short Message Service Centre SMSC.
The SMSC forwards 8 Intercept Related Information IRI related to the subscriber via the X2 interface to the delivery function DF2 and from DF2- to the Law Enforcement Monitoring Function LEMF via the HI2 interface. The IRI comprises an SMS-report of the deleted Short Message.
A report of the unsuccessfully delivered Short Message is sent from the SMSC to the subscriber B.

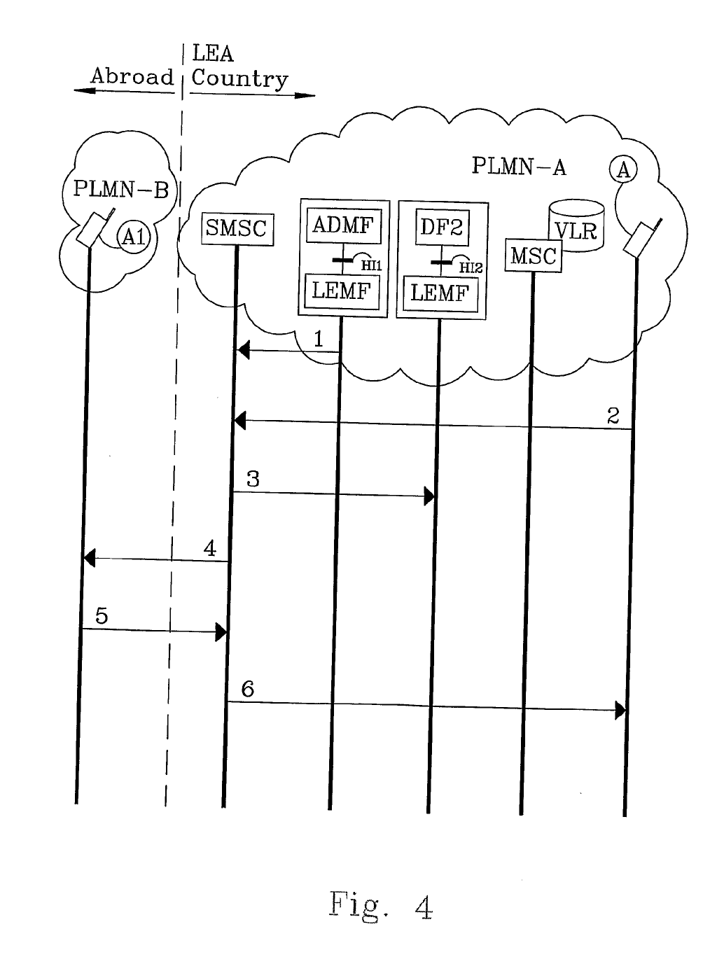

FIG. 4 discloses a method according to a second embodiment of the invention. The second embodiment discloses a method for SMS interception when a target subscriber A1 that belongs to PLMN-A temporarily is located abroad within PLMN-B. The subscriber A1 is the recipient of a Short Message sent from subscriber A in PLMN-A. The Law Enforcement Agency to which LEMF belongs has no jurisdiction of the nodes in PLMN-B. The method according to the second embodiment comprises the following method steps:
The Law Enforcement Monitoring Function LEMF sends via the HI1 interface, a request 1 to the Administration Function ADMF to activate interception of Short Messages related to the mobile subscriber A1. The subscriber identity (MSISDN) is sent in the request 1 and defines subscriber A1. The ADMF forwards the requests 1 via the interface X1 to the Short Message Service Centre SMSC. The received subscriber identity is stored in the SMSC.
A Short Message is sent 2 from the mobile subscriber A in PLMN-A to the SMSC. The Short Message comprises an identification number of subscriber A1 as called party.
The called party number is received in the SMSC. The received information is stored in the SMSC.
The SMSC verifies that the received subscriber number identifies subscriber A1 as a target.
The SMSC forwards 3 Intercept Related Information IRI related to the subscriber A1 via the X2 interface to the delivery function DF2 and from DF2 to the Law Enforcement Monitoring Function LEMF via the HI2 interface. The IRI comprises an SMS-report of the received Short Message.
The SMSC relays 4 the Short Message to subscriber A1 located in PLMN-B.
An acknowledgement 5 of the received Short Message is sent from subscriber A1 to SMSC.
A report 6 of the successfully delivered Short Message is sent from the SMSC to the subscriber A.

Other examples of originating path's when the invention is applicable are (assuming that the originating short message entity is authorized to use the SMSC in PLMN-A):
Originating subscriber is a 2 G/3 G mobile phone also roaming abroad.
Originating Short Message Entity is an e-mail subscription with e-mail server also abroad.
Originating Short Message Entity is a wireline subscription also abroad.
Originating Short Message Entity is an application directly connected to the SMSC.

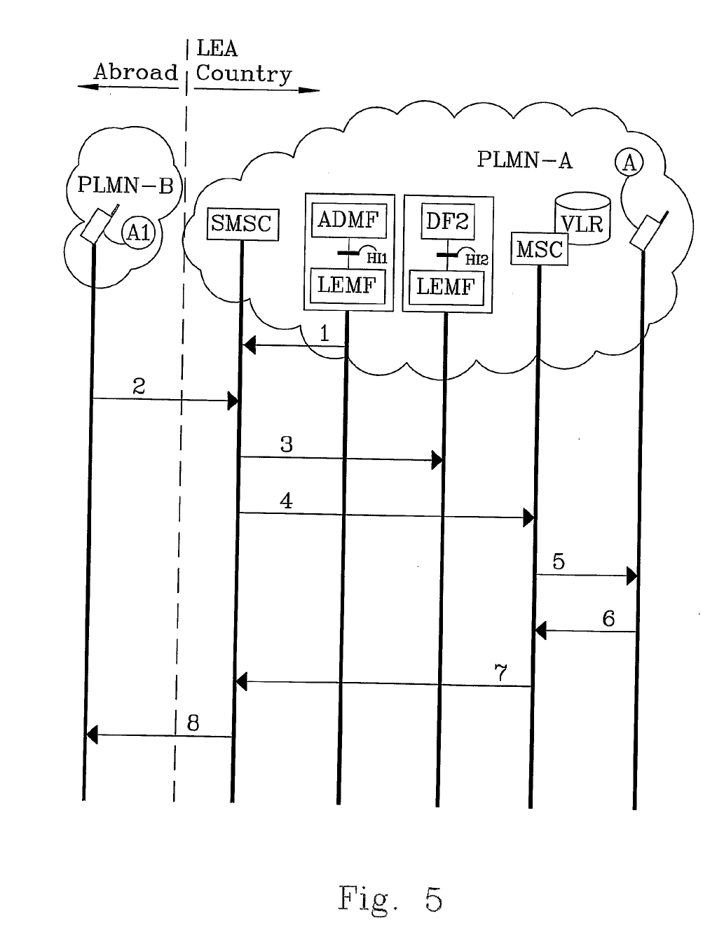

FIG. 5 discloses a method according to a third embodiment of the invention. The third embodiment discloses a method for SMS interception when a target subscriber A1 that belongs to PLMN-A temporarily is located abroad within PLMN-B. The subscriber A1 is the originator of a Short Message sent to subscriber A in PLMN-A. The method according to the third embodiment comprises the following method steps:
The Law Enforcement Monitoring Function LEMF sends to the Short Message Service Centre SMSC a request 1 to activate interception of Short Messages related to the mobile subscriber A1. The subscriber identity is sent in the request 1 and defines subscriber A1. The received subscriber identity is stored in the SMSC.
A Short Message is sent 2 from the mobile subscriber A1 in PLMN-B to the SMSC. The Short Message comprises a number identifying subscriber A1 as calling party.
The calling party number is received in the SMSC. The received information is stored in the SMSC.
The SMSC verifies that the received subscriber number identifies subscriber A1 as a target.
The SMSC forwards 3 Intercept Related Information IRI related to the subscriber A1 to the Law Enforcement Monitoring Function LEMF. The IRI comprises an SMS-report of the received Short Message.
The SMSC relays 4, 5 the Short Message to subscriber A located in PLMN-A via the MSC in which area A is located.
An acknowledgement 6, 7 of the received Short Message is sent from subscriber A to SMSC via the MSC.
A report 8 of the successfully delivered Short Message is sent from the SMSC to the subscriber A1.

Other examples of terminating path's when the invention is applicable are:
Recipient subscriber is a 2 G/3 G mobile phone also roaming abroad.
Recipient Short Message Entity is an e-mail subscription with e-mail server also abroad.
Recipient Short Message Entity is a wireline subscription also abroad.
Recipient Short Message Entity is an application directly connected to the SMSC.

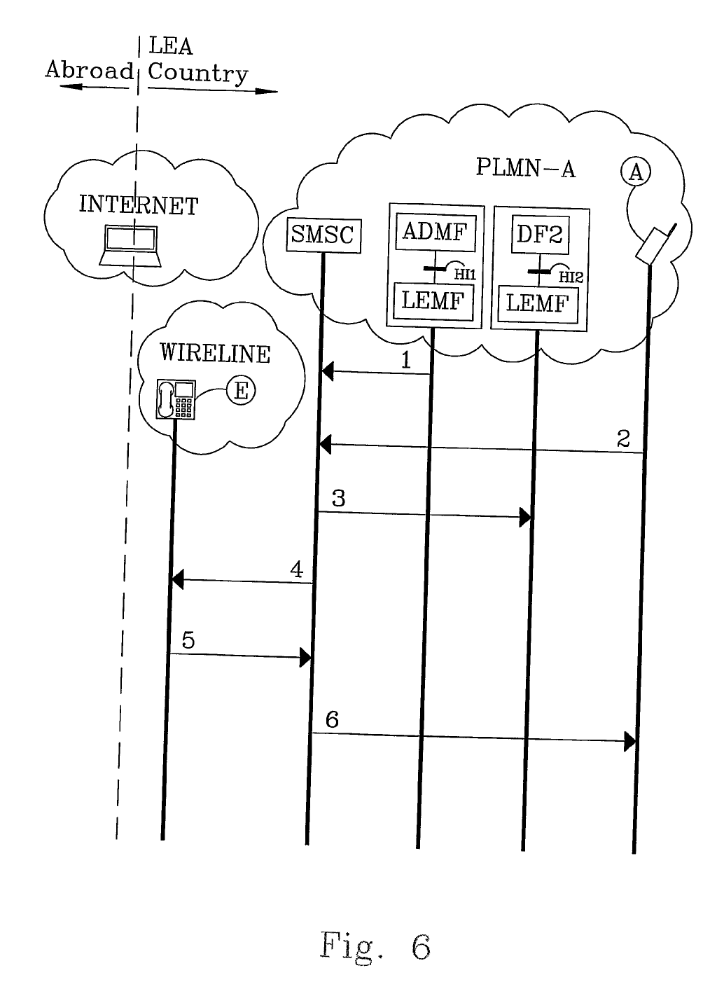

FIG. 6 discloses a method according to a fourth embodiment of the invention. The fourth embodiment discloses a method for SMS interception when a target subscriber E belongs to a wireline network (alternatively the target subscriber in the example below is a user of a computer terminal that belongs to the internet network). The subscriber E is the recipient of a Short Message sent from subscriber A. The Law Enforcement Agency to which LEMF belongs has no jurisdiction of the nodes in the wireline network. The method according to the fourth embodiment comprises the following method steps:
The Law Enforcement Monitoring Function LEMF sends to the Short Message Service Centre SMSC a request 1 to activate interception of Short Messages related to the wireline subscriber E (called number). A wireline subscriber number is sent in the request 1 and defines subscriber E. The received subscriber identity is stored in the SMSC.
A Short Message is sent 2 from the mobile subscriber A in PLMN-A to the SMSC. The Short Message SM comprises a wireline number that identifies subscriber E as called party.
The called party number is received in the SMSC. The received information is stored in the SMSC.
The SMSC verifies that the received subscriber number identifies subscriber E as a target.
The SMSC forwards 3 Intercept Related Information IRI related to the subscriber E to the Law Enforcement Monitoring Function LEMF. The IRI comprises an SMS-report of the received Short Message.
The SMSC relays 4 the Short Message to subscriber E located in the wireline network.
An acknowledgement 5 of the received Short Message is sent from subscriber E to SMSC.
A report 6 of the successfully delivered Short Message is sent from the SMSC to the subscriber A.

As is already mentioned, the fourth embodiment is valid also for a target subscriber that belongs to the internet network and is located abroad or in LEA Country. If so, an e-mail address is received in the SMSC instead of a wireline number.

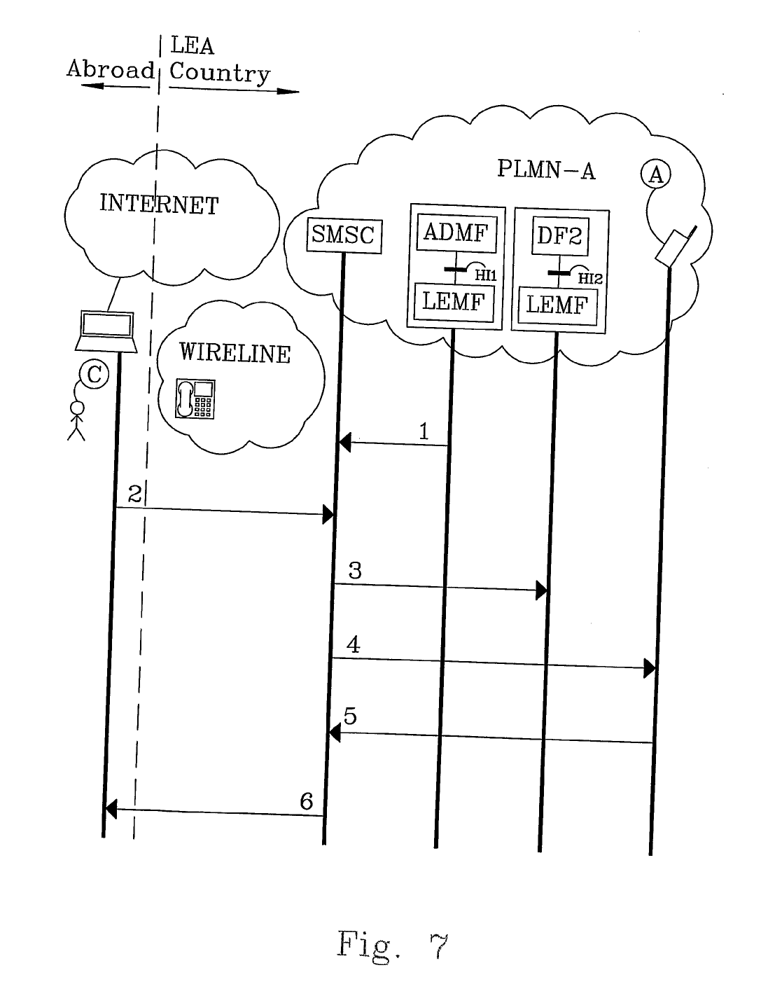

FIG. 7 discloses a method according to a fifth embodiment of the invention. The fifth embodiment discloses a method for SMS interception when a target subscriber C is a user of a computer terminal that connected to the internet network (alternatively the target subscriber in the example below belongs to the wireline network). The subscriber C is the originator of a Short Message sent to subscriber A located in PLMN-A. The originating short message entity is authorized to use the SMSC in PLMN-A. The method according to this embodiment comprises the following method steps:
The Law Enforcement Monitoring Function LEMF sends to the Short Message Service Centre SMSC a request 1 to activate interception of Short Messages related to the internet subscriber C. An e-mail address is sent in the request 1 and defines subscriber C. The received subscriber identity is stored in the SMSC.
A Short Message is sent 2 from the internet subscriber C to the SMSC. The Short Message SM comprises an e-mail address that identifies subscriber C as originator of the SM, i.e. the calling party.
The e-mail address of the calling party is received in the SMSC. The received information is stored in the SMSC.
The SMSC verifies that the received e-mail address identifies subscriber C as a target.
The SMSC forwards 3 Intercept Related Information IRI related to the subscriber C to the Law Enforcement Monitoring Function LEMF. The IRI comprises an SMS-report of the received Short Message.
The SMSC relays 4 the Short Message to subscriber A located in PLMN-A.
An acknowledgement 5 of the received Short Message is sent from subscriber A to SMSC.
A report 6 of the successfully delivered Short Message is sent from the SMSC to the subscriber C.
As is already mentioned, the fifth embodiment is valid also for a target subscriber that belongs to the wireline network, is authorized to use the SMSC in PLMN-A and is located abroad or in LEA country. If so, a wireline number (calling party) is received in the SMSC instead of an e-mail address.

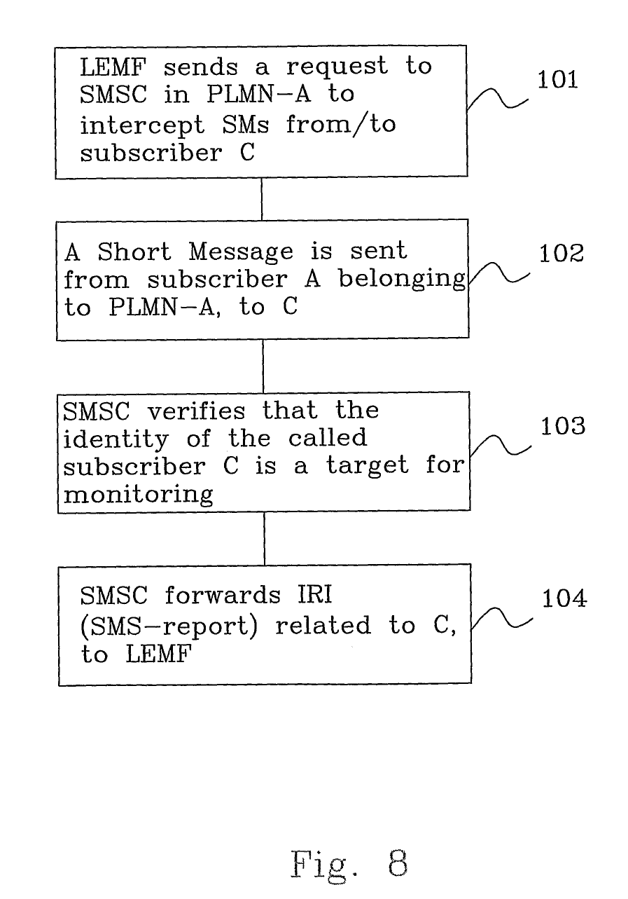

FIG. 8 discloses a flowchart in which some more important method steps are shown. The flowchart is to be read together with earlier shown figures. The flowchart comprises the following steps:
The Law Enforcement Monitoring Function LEMF sends a request to activate interception of Short Messages related to a mobile subscriber C in a telecommunication system TS. The request is sent to the Short Message Service Centre SMSC responsible for relaying Short Messages to/from all subscribers belonging to a telecommunication network PLMN-A within the telecommunication system. A block 101 discloses this step in FIG. 8.
A Short Message is sent 2 to the SMSC from the mobile subscriber A belonging to the telecommunication network. The Short Message comprises an identity that identifies subscriber C as called party. A block 102 discloses this step in FIG. 8.
The SMSC verifies that the received subscriber identity identifies subscriber C as a target for monitoring. A block 103 discloses this step in FIG. 8.
The SMSC forwards Intercept Related Information IRI related to the monitored subscriber C to the Law Enforcement Monitoring Function LEMF. The IRI comprises an SMS-report. A block 104 discloses this step in FIG. 8.

Below is shown the ASN.1 description relevant for SMS interception including the modification introduced by the invention for example to the 3GPP 33.108 standard:

IRI-Parameters ::= SEQUENCE
{

| | |
|---|---|
| hi2DomainId | [0] OBJECT IDENTIFIER, -- 3GPP HI2 domain |
| iRIversion | [23] ENUMERATED |

```
  {
    version2(2),
    ...
  } OPTIONAL,
    -- if not present, it means version 1 is handled
  lawfulInterceptionIdentifier  [1] LawfulInterceptionIdentifier,
    -- This identifier is associated to the target.
```

| | |
|---|---|
| timeStamp | [3] TimeStamp, |

-- date and time of the event triggering the report.)

| | |
|---|---|
| initiator | [4] ENUMERATED |
| { | |
| not-Available | (0), |
| originating-Target | (1), |

```
      -- in case of GPRS, this indicates that the PDP context activation
      -- or deactivation is MS requested
```

| | |
|---|---|
| terminating-Target | (2), |

```
      -- in case of GPRS, this indicates that the PDP context activation or
      -- deactivation is network initiated
  ...
  } OPTIONAL,
```

| | |
|---|---|
| locationOfTheTarget | [8] Location OPTIONAL, |

-- location of the target subscriber

| | |
|---|---|
| partyInformation | [9] SET SIZE (1..10) OF PartyInformation OPTIONAL, |

```
    -- This parameter provides the concerned party, the identiy(ies) of the party
    --)and all the information provided by the party.
```

| | |
|---|---|
| serviceCenterAddress | [13] PartyInformation OPTIONAL, |

```
    -- e.g. in case of SMS message this parameter provides the address of the
relevant
    -- server within the calling (if server is originating) or called (if server is
    -- terminating) party address parameters
```

| | |
|---|---|
| sMS | [14] SMS-report OPTIONAL, |

-- this parameter provides the SMS content and associated information

| | |
|---|---|
| national-Parameters | [16] National-Parameters OPTIONAL, |
| gPRSCorrelationNumber | [18] GPRSCorrelationNumber OPTIONAL, |
| gPRSevent | [20] GPRSEvent OPTIONAL, |

```
    -- This information is used to provide particular action of the target
    -- such as attach/detach
```

| | |
|---|---|
| sgsnAddress | [21] DataNodeAddress OPTIONAL, |
| gPRSOperationErrorCode | [22] GPRSOperationErrorCode OPTIONAL, |
| ggsnAddress | [24] DataNodeAddress OPTIONAL, |
| qOS | [25] UmtsQos OPTIONAL, |
| networkIdentifier | [26] Network-Identifier OPTIONAL, |
| sMSOriginatingAddress | [27] DataNodeAddress OPTIONAL, |
| sMSTerminatingAddress | [28] DataNodeAddress OPTIONAL, |
| iMSevent | [29] IMSEvent OPTIONAL, |
| sIPMessage | [30] OCTET STRING OPTIONAL, |
| servingSGSN-number | [31] OCTET STRING (SIZE (1..20)) OPTIONAL, |
| servingSGSN-address | [32] OCTET STRING (SIZE (5..17)) OPTIONAL, |
| | -- Octets are coded according to 3GPP TS 23.003 [25] |
| ... | |
| } | |

```
PartyInformation ::= SEQUENCE
{
party-Qualifier [0] ENUMERATED
{
    originating-Party(0),
        --In this case, the partyInformation parameter provides the identities
related to
        --the originating party and all information provided by this party.
      --This parameter provides also all the information concerning the
      redirecting
      --party when a forwarded call reaches a target.
    terminating-Party(1),
      --In this case, the partyInformation parameter provides the identies related
to
      --the terminating party and all information provided by this party.
    forwarded-to-Party(2),
      --In this case, the partyInformation parameter provides the identies related
to
      --the forwarded to party and parties beyond this one and all information
      --provided by this parties, including the call forwarding reason .
    gPRS-Target(3),
    ...
  },
  partyIdentity [1] SEQUENCE
  {
    imei [1] OCTET STRING (SIZE (8)) OPTIONAL,
      --See MAP format [32]
    tei [2] OCTET STRING (SIZE (1..15)) OPTIONAL,
      --ISDN-based Terminal Equipment Identity
    imsi [3] OCTET STRING (SIZE (3..8)) OPTIONAL,
      --See MAP format [32] International Mobile
      --Station Identity E.212 number beginning with Mobile Country Code
    callingPartyNumber [4] CallingPartyNumber OPTIONAL ,
      --The calling party format is used to transmit the identity of a calling
party
    calledPartyNumber [5] CalledPartyNumber OPTIONAL ,
      --The called party format is used to transmit the identy of a called party
or
      --a forwarded to party.
    msISDN [6] OCTET STRING (SIZE (1..9)) OPTIONAL,
      -- MSISDN of the target, encoded in the same format as the AddressString
      -- parameters defined in MAP format document ref [32], § 14.7.8
    ...,
    email-ID IA5String (SIZE(1..512)),
      -- rfc822-compliant email address. E-mail address of the target in case of
      SMS
      -- interworking with e-mail service
  },
  services-Information [2] Services-Information OPTIONAL,
    --This parameter is used to transmit all the information concerning the
    --complementary information associated to the basic call
  supplementary-Services-Information [3] Supplementary-Services OPTIONAL,
    --This parameter is used to transmit all the information concerning the
    --activation/invocation of supplementary services during a call or out-of call
    not
    --provided by the previous parameters.
  services-Data-Information [4] Services-Data-Information OPTIONAL,
    -- This parameter is used to transmit all the information concerning the
    complementary
    -- information associated to the basic data call
  ...
}
SMS-report ::= SEQUENCE
{
    communicationIdentifier [1] CommunicationIdentifier,
      -- used to uniquely identify an intercepted call : the same used for the
      -- relevant IRI
      -- called CallIdentifier in Ed.1 of the document
    timeStamp [2] TimeStamp,
      --date and tine of the report. The format is
      --the one defined in case a) of the ASN1 recommendation [33].
      --(year month day hour minutes seconds)
    sMS-Contents [3] SEQUENCE
    {
      initiator [1] ENUMERATED
      {
          --party which sent the SMS
          target(0),
          server(1),
          undefined-party(2),
          ...
      },
      transfer-status [2] ENUMERATED
      {
```

| | |
|---|---|
| succeed-transfer(0), | --the transfer of the SMS message succeeds |

```
          not-succeed-transfer(1),
          undefined(2),
          ...,
```

| | |
|---|---|
| received-in-SMSC(3), | -- the SMS has been received in SMSC |
| deleted-from-SMSC(4) | -- the SMS message has been definitively removed |
| from the SMSC | |
| | -- due to expiration of validity period |

```
indicator.
      } OPTIONAL,
      other-message [3] ENUMERATED
      {
          --in case of terminating call, indicates if the server will send
          --other SMS
          yes(0),
          no(1),
          undefined(2),
          ...
      } OPTIONAL,
      content [4] OCTET STRING (SIZE (1 .. 270)) ,
          --Encoded in the format defined for the SMS mobile
          --The SMSC shall include the whole TPDU at SM-TP layer.
          ...
```

Note that the SMSC shall include in the SMS content field the whole TPDU at SM-TP layer including the validity period field. This field is intended for SMSC use only and is not relayed to the MSC/SGSN at SMS delivery attempt. In the figures enumerated items are shown as individual elements. In actual implementations of the invention, however, they may be inseparable components of other electronic devices such as a digital computer. Thus, actions described above may be implemented in software that may be embodied in an article of manufacture that includes a program storage medium. The program storage medium includes data signal embodied in one or more of a carrier wave, a computer disk (magnetic, or optical (e.g., CD or DVD, or both), non-volatile memory, tape, a system memory, and a computer hard drive.

The invention is of course not limited to the above described and in the drawings shown embodiments but can be modified within the scope of the enclosed claims. Two or more telecommunication networks of the same type can for example share a Short Message Service Centre. If two telecommunication networks share the same SMSC, the SMSC is responsible for relaying, store and forwarding of Short Messages to and from subscribers belonging to both networks. A Short Message Service Centre can be part of another type of network than the above disclosed Public Land Mobile Network. The SMSC (or similar) can be part of for example a wireline network, a paging network or an internet network and is then responsible for relaying, store and forwarding of Short Messages to and from subscribers belonging each network respectively.

1. A method of intercepting Short Message Services in a telecommunication system comprising at least one telecommunication Network that comprises an Access Point responsible for relaying Short Messages to/from all subscribers belonging to the telecommunication network, the method comprising the steps of:
receiving to the Access Point, a request to monitor Short Messages related to a subscriber in the telecommunication system;
registering in the Access Point a Short Message to/from a subscriber belonging to the telecommunication network, which short message is related to the monitored subscriber;
delivering to a Law Enforcement Monitoring Function from the Access Point, information related to the registered Short Message.
using the delivered information for law enforcement purposes.

2. The method according to claim 1, comprising the following further steps:
registering in the Access Point expiration of validity period associated with the Short Message;
delivering from the Access Point, information related to the registered expiration of validity period and the registered Short Message.

3. The method according to claim 1 whereby the monitored subscriber belongs to the telecommunication network but is located as roaming subscriber in another network.

4. The method according to claim 1 whereby the monitored subscriber is identified by an E-mail address.

5. The method according to claim 1 whereby a subscriber number in a Wireline network identifies the monitored subscriber.

6. The method according to claim 1 whereby the monitored subscriber is identified by any known subscriber identity.

7. The method according to claim 1 whereby the Short Message is transmitted to/from a subscriber that belongs to the telecommunication network.

8. The method according to claim 7 whereby the telecommunication network is any one of the following:
a Public Land Mobile Network;
a wireline network;
an internet network.

9. An arrangement to intercept Short Message Services in a telecommunication system (TS) comprising at least one telecommunication Network that comprises an Access Point; responsible for relaying Short Messages to/from all subscribers belonging to the telecommunication network, the arrangement comprising:
means for receiving in the Access Point, a request to monitor Short Messages related to a subscriber in the telecommunication system;
means for registering in the Access Point a Short Message to/from a subscriber belonging to the telecommunication network, which short message is related to the monitored subscriber;
means for delivering to a Law Enforcement Monitoring Function from the Access Point, information related to the registered Short Message.
means for receiving the delivered information to a Law Enforcement Monitoring Function;

10. The arrangement to intercept Short Message Services according to claim 9, further comprising:
means for registering in the Access Point of expiration of validity period associated with the Short Message; and
means for delivering from the Access Point, information related to the registered expiration of validity period and the registered Short Message.

11. The arrangement to intercept Short Message Services according to claim 9 whereby the monitored subscriber belongs to the telecommunication network but is located as roaming subscriber in another network.

12. The arrangement to intercept Short Message Services according to claim 9 whereby the monitored subscriber is identified by an E-mail address.

13. The arrangement to intercept Short Message Services according to claim 9 whereby a subscriber number in a Wireline network identifies the monitored subscriber.

14. The arrangement to intercept Short Message Services according to claim 9 whereby the monitored subscriber is identified by any known subscriber identity.

15. The arrangement to intercept Short Message Services according to claim 9 whereby the Short Message is transmitted to/from a subscriber that belongs to the telecommunication network.

16. The arrangement to intercept Short Message Services according to claim 15 whereby the telecommunication network is any one of the following:
a Public Land Mobile Network;
a wireline network;
an internet network.

17. An article of manufacture comprising a program storage medium having computer readable program code embodied therein for intercepting Short Message Services in a telecommunication system comprising at least one telecommunication Network that comprises an Access Point responsible for relaying Short Messages to/from all subscribers belonging to the telecommunication network, the computer readable program code in the article of manufacture comprising:
computer readable code for receiving to the Access Point, a request to monitor Short Messages related to a subscriber in the telecommunication system;
computer readable code for registering in the Access Point a Short Message to/from a subscriber, which short message is related to the monitored subscriber;
computer readable code for delivering from the Access Point to a Law Enforcement Monitoring Function, information related to the registered Short Message.
computer readable code for using the delivered information for law enforcement purposes.
